(19) United States
(12) Patent Application Publication
(10) Pub. No.: US 2020/0240372 A1
(43) Pub. Date: Jul. 30, 2020

(54) DUAL STAGE AIR FILTER SYSTEM

(71) Applicant: Santos Gonzalez, Newnan, GA (US)

(72) Inventor: Santos Gonzalez, Newnan, GA (US)

(21) Appl. No.: 16/258,660

(22) Filed: Jan. 27, 2019

(51) Int. Cl. F02M 35/022; F02B 37/013; F02B 37/00; F02M 35/024; F02M 35/10

(52) U.S. Cl. CPC F02M 35/022; F02B 37/013; F02M 35/10; F02M 35/024; F02B 37/004

(57) ABSTRACT

A dual stage air filter system including a vent for receiving supply air from an air handler unit, a filter box attached to a back side of the vent, the filter box adapted to be mounted in fluid communication with a supply air passage from the air handler unit and passed through the vent, the filter box including a primary filter enclosed in the filter box for filtering air particles from the supply air received from the vent, and a duct collar attached to a backside of the filter box, the duct collar adapted to be mounted in fluid communication with the supply air passage from the air handler unit and passed through the vent and passed through the primary filter, the duct collar includes a secondary filter enclosed in the duct collar for filtering air particles from the supply air received from the primary filter.

### FIELD OF THE INVENTION

Embodiments described herein generally relate to air filters for centralized air systems, and more particularly to a dual stage air filter system for a centralized air system.

### BACKGROUND OF THE INVENTION

Dust and debris in a home air filter restrict air flow, which forces the furnace to strain and use more energy to heat or cool the home. Just like replacing a car engine's oil and air filter every 3,000 miles, a clean HVAC air filter protects the furnace system from becoming damaged and, ultimately, failing entirely. When conventional air filters are clogged, the air handler has to work harder in order to compensate for the blockage of air flow. Hence, an improved air filtration system is desirable to preserve the lifeline of the air handler unit.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary view of a dual stage air filter system according to an embodiment of the present disclosure.

FIG. 2 shows an exemplary view of a dual stage air filter system according to an embodiment of the present disclosure.

### SUMMARY OF THE INVENTION

Exemplary embodiments disclosed herein describe a dual stage air filter system including a vent for receiving supply air from an air handler unit, a filter box attached to a back side of the vent, the filter box adapted to be mounted in fluid communication with a supply air passage from the air handler unit and passed through the vent, the filter box including a primary filter enclosed in the filter box for filtering air particles from the supply air received from the vent; and a duct collar attached to a backside of the filter box, the duct collar adapted to be mounted in fluid communication with the supply air passage from the air handler unit and passed through the vent and passed through the primary filter, the duct collar includes a secondary filter enclosed in the duct collar for filtering air particles from the supply air received from the primary filter.

In some exemplary embodiments, the vent includes a vent frame for receiving the filter box.

In some exemplary embodiments, the primary filter is enclosed in a pull out filter unit.

In some exemplary embodiments, the filter box is a galvanized filter box.

In some exemplary embodiments, the vent is attached to a supply plenum.

In some exemplary embodiments, the duct collar is attached to a supply duct for distributing the filtered air to one or more supply vents.

### DETAILED DESCRIPTION

The present disclosure relates to a dual stage air filter system (“the system”). In conventional HVAC systems, air supplied from an air handler system is distributed through a duct system to a supply vent and an air filter is used to filter the return air. The disclosed dual stage air filter system filters the air supplied from the air handler unit using a primary filter in a filter box and a secondary filter in a duct collar. The dual stage air filter system can be retrofitted to conventional centralized air systems by replacing the traditional duct collar with the dual stage air filter system. The system can be used for residential and commercial establishments.

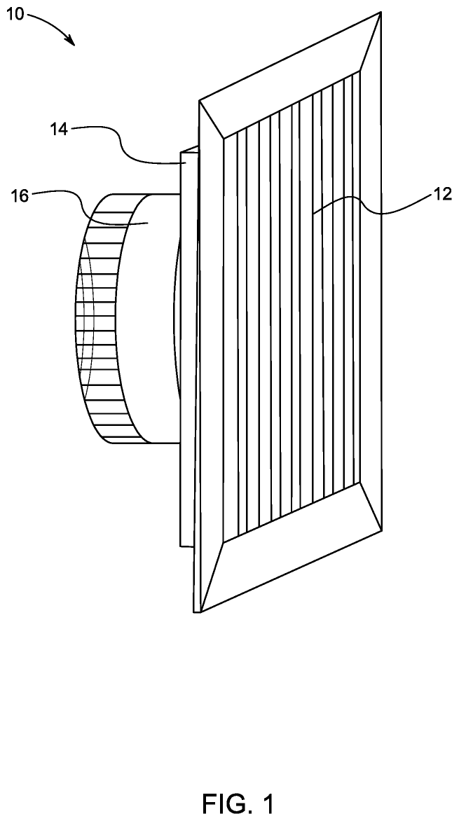

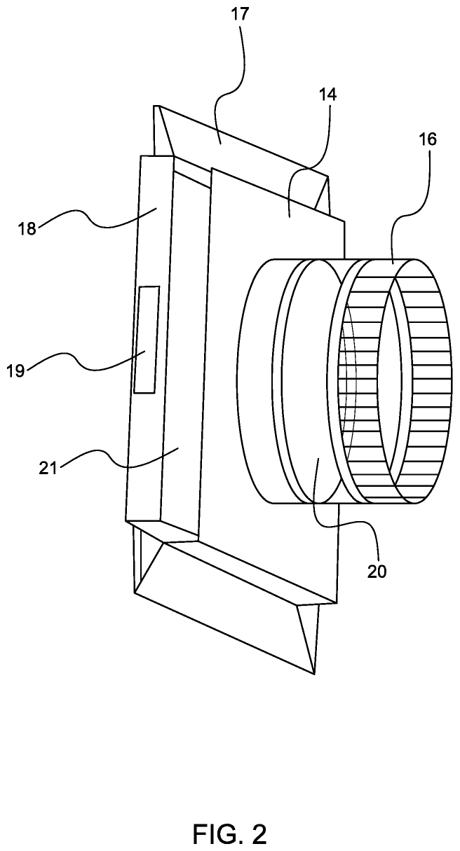

As illustrated in FIGS. 1-2, the dual stage air filter system 10 includes a vent 12, a filter box 14, and a duct collar 16. The vent 12 receives supply air from an air handler unit. The front side of the vent is attached to a supply plenum and the supply plenum is attached directly to the output of the air handler unit. The back side of the vent is attached to filter box 14. The vent includes a vent frame 17 for receiving the filter box. The vent may be made from any suitable material such as, for example, metal or plastic.

The filter box 14 is attached to the back side of vent 12 and is adapted to be mounted in fluid communication with the supply air passage from the air handler unit and passed through the vent 12. The filter box may be made from any suitable material. In a preferred embodiment, the filter box is galvanized. The filter box includes a pull out filter unit 18 which is slideably enclosed in the filter box. The pull out filter unit includes a frame having a handle 19 and an enclosure 21 for receiving a primary filter. The frame may be slideably inserted and removed from the filter box. The primary filter enclosed in the filter box filters air particles, such as, for example, dust, from the supply air supplied from the air handler unit and received from the vent. The primary filter may be any suitable filter, such as, for example, fiberglass filter, polyester and pleated filters, high efficiency particulate arrestance (HEPA) filters, etc.

The duct collar 16 is attached to a backside of the filter box 14 and is adapted to be mounted in fluid communication with the supply air passage from the air handler unit and passed through the vent 12 and passed through the primary filter. The duct collar includes a secondary filter 20 enclosed in the duct collar for filtering air particles from the supply air received from the primary filter. The duct collar is attached to a supply duct channel for distributing the filtered air to one or more supply vents. The duct collar may be made from any suitable material, and in a preferred embodiment, the duct collar is galvanized. The secondary filter may be any suitable filter, such as, for example, fiberglass filter, polyester and pleated filters, HEPA filters, etc.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A dual stage air filter system comprising:
a vent for receiving supply air from an air handler unit;
a filter box attached to a back side of the vent, the filter box adapted to be mounted in fluid communication with a supply air passage from the air handler unit and passed through the vent, the filter box including a primary filter enclosed in the filter box for filtering air particles from the supply air received from the vent; and
a duct collar attached to a backside of the filter box, the duct collar adapted to be mounted in fluid communication with the supply air passage from the air handler unit and passed through the vent and passed through the primary filter, the duct collar including a secondary filter enclosed in the duct collar for filtering air particles from the supply air received from the primary filter.

2. The system of claim 1, wherein the vent includes a vent frame for receiving the filter box.

3. The system of claim 1, wherein the primary filter is enclosed in a pull out filter unit.

4. The system of claim 1, wherein the filter box is a galvanized filter box.

5. The system of claim 1, wherein the vent is attached to a supply plenum.

6. The system of claim 1, wherein the duct collar is attached to a supply duct channel for distributing the filtered air to one or more supply vents.
